(19) United States
(12) Patent Application Publication
(10) Pub. No.: US 2017/0313921 A1
(43) Pub. Date: Nov. 2, 2017

(54) SEALING MATERIAL FOR THREADED CONNECTIONS

(71) Applicants: Josef BACHMAIR, Ungenach (AT); Josef SEIRINGER, Ungenach (AT)

(72) Inventors: Josef BACHMAIR, Ungenach (AT); Josef SEIRINGER, Ungenach (AT)

(21) Appl. No.: 15/523,466

(22) PCT Filed: Oct. 27, 2015
(86) PCT No.: PCT/AT2015/000135

§ 371 Date: May 1, 2017

(30) Foreign Application Priority Data
Oct. 31, 2014 (EP) 14191216.2

(51) Int. Cl. C09K 3/10; D01F 6/12; C08K 3/22; C08K 3/30; F16L 15/04

(52) U.S. Cl. CPC C09K 3/1009; C08K 3/30; D01F 6/12; F16L 15/04; C08K 3/22; C08K 2003/2241; C08K 2003/3009; C09K 2200/0637; C09K 2200/0692; C08K 2201/019

(57) ABSTRACT

A flexible sealing material for threaded connections made from, in particular, a strip or threadlike PTFE-mono or multi-filament. The aim of the invention is to provide advantageous sealing conditions in which the filament is made from an undrawn PTFE which is strip or threadlike and which is modified with high pressure additives.

The invention relates to a flexible sealing material for screw-thread connections made of a flexible PTFE mono- or multifilament in particular in the form of tape or of thread.

Sealing elements of this type, in particular sealing tapes or sealing threads, serve as seals for a very wide variety of connections, for pipe connections or for the sealing of screw threads made of metal or plastic. To this end, polytetrafluoroethylene threads or polytetrafluoroethylene tapes are wound around the screw-thread flights that require sealing, before the screw-thread connection is completed. These sealing elements serve as replacement for the hemp previously used for the sealing of screw threads in pipe runs. They are currently used in a very wide variety of forms, specific examples being sealing tapes and sealing threads. The sealing tapes available in the market are always a PTFE monofilament in oriented form, mostly equipped with perfluorinated lubricant on the surface or requiring the application of that type of lubricant on the surface.

As early as 1961, U.S. Pat. No. 3,002,270 A publically proposed use of a tape of PTFE (polytetrafluoroethylene) as sealing interlayer between male and female screw threads in pipe connections. The tape is produced by mixing pulverulent PTFE with a small proportion of an oily addition, extrusion, and rolling in a calender roll system to give a long, thin tape, and finally winding-up. In the calender roll system, or downstream thereof, the tape is stretched in such a way that its density becomes from 1.2 to 1.8 g/mm³.

It is known that when screw-thread connections are completed a requirement for subsequent adjustments often makes it inevitable that said screw-threaded joint is separated again and reconnected. However, it is essential here that a leakproof connection is guaranteed during, and also after, this procedure. Compliance with this specific requirement with the PTFE-monofilament products currently available in the market can be ensured only to a limited extent with separate application of perfluorinated lubricant to the PTFE monofilament. In other cases it is always necessary that the sealing element is also replaced after separation of the screw-threaded joint, in order to ensure that it has the required leakproof quality.

EP 0801254 A1 (published 1997) describes a material for parts which have not only to act as slides for movable valve parts but must also be durable, and also seal; typically, therefore, these parts are bearing bushes for stopper valves. The material is a PTFE enriched with additives. The additives are particles of solid lubricants with lamellar crystal structure, for example talc powder or graphite. The production process extrudes and/or calenders (rolls) the mixture of materials to give a tape, winds this up to give a roll, compresses it in the form of roll and finally sinters it at a temperature of about 380° C. for a number of hours to give a compact, relatively hard product with durably good low-friction surface. The extrusion and/or calendering achieves orientation, in a manner ideal for low-friction properties, of the lamellar crystals of the additives parallel to the surface of the resultant tape and finally of the finished rigid product. There is no intention, and certainly no suggestion, that the intermediate product in the form of tape is used for sealing purposes.

Starting from current state of the art, the invention is based on the object of providing a sealing material for a flexible sealing element which serves as sealing interlayerer between male and female screw threads in particular for pipe connections while exhibiting improved sealing properties and permitting to a certain extent a subsequent adjustment of a screw-threaded joint without any resultant requirement for replacement of said element; this also applies under conditions of pressure.

The invention achieves this object in that the sealing material is a PTFE mono- or multifilament which is in particular in the form of tape or of thread and which has been modified with high-pressure additives and is unoriented.

Because the sealing material is not sintered (like the sealing material in EP 0801254 A1, which is comparable in a number of respects), it remains relatively soft and relatively flexible, and has a relatively high coefficient of friction, and therefore does not slip out of position during correct assembly of a sealing screw-threaded joint. Production cost is moreover very much lower.

Because the sealing material is not oriented (like the PTFE sealing tapes or sealing threads mentioned in the introduction), it is denser, less porous, and more deformable than, and has softer plastic properties than, oriented material. The good plastic deformability is likely to be responsible for the fact that when the material is used as interlayer during the assembly and adjustment of male and female screw-threaded parts of a sealing screw-threaded connection it provides a good lubrication effect, such that there is no need for any additional substances such as oil.

High-pressure additives take the form of fine-particle powder, and are classified into substances exerting structural, chemical or physical effects. Among the most commonly used high-pressure additives are molybdenum disulfide, graphite, tricalcium phosphate, zinc pyro-phosphate, calcium hydroxide, aluminum, zinc sulfide, zinc oxide and calcium fluoride. Titanium dioxide can likewise be used as high-pressure additive, with the advantage that it can be used in the food industry.

Although PTFE itself has a very low coefficient of friction, it does not have a layer-lattice structure, and exerts only a physical effect. Modification of PTFE with high-pressure additives which have a layer-lattice structure and also exert a chemical effect is therefore particularly advantageous for the use as sealing thread for screw threads. Materials particularly attractive for this purpose are molybdenum sulfide (MoS2), tungsten disulfide (WS2), and titanium dioxide (TiO2), mixtures thereof and other similar high-pressure additives.

The substantial advantage of the sealing material of the invention is that it remains possible to make subsequent adjustments to the screw-threaded joint after assembly; this also applies under conditions of pressure. In particular, a screw-threaded joint which has been tightened after the sealing material has been wound thereon can be separated to the extent of at least a quarter revolution with no risk that it may leak. Modification of the unoriented PTFE monofilament with high-pressure additives results in improved resistance to deformation under compression.

The mode of operation of high-pressure additives is based on their crystalline structure, which allows them to exert a lubrication effect without altering the metallic surface. Layer-lattice crystals usually, by virtue of their structure, have one plane in which they are significantly easier to cleave; the lamellae therefore slide across one another like a stack of paper. This low internal friction is significant for lubrication properties. The result is therefore that under increasing pressure a low-friction film forms between the metal surfaces, and ensures freedom of movement.

High-pressure additives are advantageously from 0.1 to 5.0 percent by weight of the filament. Even addition of 0.1% of high-pressure additives provides significant improvements in the properties of the materials, but additions above 5.0% are neither cost-effective nor useful.

A substantial advantage of the invention is that the unoriented PTFE film which has been modified with high-pressure additives has the required improved sealing properties and permits subsequent adjustment of a screw-thread joint to a certain extent without damage to the sealing means; this also applies under conditions of pressure. This advantage is in essence attributable to the fact that introduction of high-pressure additives into the polymer can control the disadvantageous cold flow of PTFE. At the same time, high-pressure additives serve as dry lubricants, replacing additional application of perfluorinated lubricant. The sealing element can take any desired form, but in particular is a universal sealing element, irrespective of form, in particular sealing tape or sealing thread of any desired width and thickness. Appropriate trials with PTFE films produced for the sealing purposes mentioned or with sealing tapes or sealing threads cut from said films, made of unoriented PTFE which has been modified with high-pressure additives, and without perfluorinated lubricant, reveal excellent results together with very good processability. The film described was tested in the form of both tape and thread at pressures up to 200 bar and above on a very wide variety of types of screw thread and of material.

The unoriented PTFE film of density from 1.20 to 1.80 g/cm³, in particular from 1.50 to 1.70 g/cm³, advantageously has the required improved sealing properties in order to permit subsequent adjustment of a screw-threaded joint to a certain extent, without damage to the sealing means.

Unmodified polytetrafluoroethylene has known advantages such as excellent chemical resistance, a very low coefficient of sliding friction, a usage range of from −200° C. to 260° C., no water absorption, no hardening, and the like, and in principle has very good suitability for the use as screw-thread sealing material in the unoriented form proposed. A considerable disadvantage of said material, however, is cold flow, which without introduction of high-pressure additives into the PTFE polymer permits subsequent adjustment only to a minimal extent. The required leakproof properties can be ensured here only to a limited extent. When high torque is applied, which is inevitable during the completion of screw-thread connections, there is likewise the risk of abrasion of the sealing surfaces. A particular risk relating to abrasion of sealing surfaces exists when screw-thread connections are made of stainless steel.

The unoriented PTFE film is produced by calendering. Any lubricant that may be required during the production of the sealing means of the invention evaporates during the drying process after calendering. In contrast to the prior art, the film web manufactured by means of a calendering process is not oriented prior to further processing to give the sealing tapes or sealing threads, and there is also no further application of lubricant, as is the case in the prior art in particular after orientation of the film. The monofilament surface is therefore lubricant-free; the meaning of this in the present context is that there is no application of any separate lubricant layer. Conventional PTFE screw-thread sealing threads or tapes available on the market are always oriented and additionally provided with lubricant.

Embedment of the high-pressure additives into the PTFE matrix, for example in the form of dry lubricants, is intended to provide a substantial improvement of the cold-flow properties of PTFE; an eventual consequence of these is to allow further undesired rotation of the screw-thread joint; this also applies under conditions of pressure. A further alternative is thus provided to the oriented sealing tapes and threads provided with perfluorinated lubricants where the lubricant has been applied only on the surface. Incorporation of high-pressure additives directly into the PTFE polymer during processing can achieve homogeneous distribution. High-pressure additives have excellent suitability as dry lubricants for applications that do not permit use of fats or oils, and they are therefore also approved for applications in oxygen pipelines. An advantage of introduction of the additives mentioned into the PTFE polymer over application of lubricants to the surface is that the lubrication property is permanently available, because the particles have been specifically embedded within the PTFE matrix and cannot evaporate. In contrast, a lubricant applied to the surfaces of PTFE sealing tapes and sealing threads can evaporate relatively easily.

In order to improve conformability during winding around a screw thread that requires sealing, it can be advantageous to perforate the film. This means perforation of the film or the sealing tape or the sealing thread perpendicularly to its longitudinal direction, for example by needles. Embossment in the form of grooves can likewise optimize application of the film or penetration into the screw-thread flights, and thus optimize the sealing effect. The groove here preferably extends across the cross section and is oriented in monofilament direction.

1. A sealing material for screw-thread connections made of a flexible PTFE mono or multifilament in particular in the form of tape or of thread, wherein the filament is composed of an unoriented PTFE which takes the form of tape or of thread and which has been modified with high-pressure additives.

2. The sealing material as claimed in claim 1, wherein high-pressure additives are from 0.1 to 5.0 percent by weight of the filament.

3. The sealing material as claimed in claim 1, wherein the high-pressure additives are selected from the group of molybdenum sulfide (MoS2), tungsten disulfide (WS2), and titanium dioxide (TiO2) or composed of mixtures thereof.

4. The sealing material as claimed in claim 1, wherein the filament is an unoriented PTFE with density from 1.20 to 1.80 g/cm3.

5. The sealing material as claimed in claim 1, wherein the monofilament surface is lubricant-free.

6. The sealing material as claimed in claim 1, wherein the PTFE monofilament has been perforated.

7. The sealing material as claimed in claim 1, wherein the PTFE monofilament has at least one groove running in longitudinal monofilament direction.

8. The sealing material as claimed in claim 2, wherein the high-pressure additives are selected from the group of molybdenum sulfide (MoS2), tungsten disulfide (WS2), and titanium dioxide (TiO2) or composed of mixtures thereof.

9. The sealing material as claimed in claim 2, wherein the filament is an unoriented PTFE with density from 1.20 to 1.80 g/cm3.

10. The sealing material as claimed in claim 3, wherein the filament is an unoriented PTFE with density from 1.20 to 1.80 g/cm3.

11. The sealing material as claimed in claim 2, wherein the monofilament surface is lubricant-free.

12. The sealing material as claimed in claim 3, wherein the monofilament surface is lubricant-free.

13. The sealing material as claimed in claim 4, wherein the monofilament surface is lubricant-free.

14. The sealing material as claimed in claim 2, wherein the PTFE monofilament has been perforated.

15. The sealing material as claimed in claim 3, wherein the PTFE monofilament has been perforated.

16. The sealing material as claimed in claim 4, wherein the PTFE monofilament has been perforated.

17. The sealing material as claimed in claim 5, wherein the PTFE monofilament has been perforated.

18. The sealing material as claimed in claim 2, wherein the PTFE monofilament has at least one groove running in longitudinal monofilament direction.

19. The sealing material as claimed in claim 3, wherein the PTFE monofilament has at least one groove running in longitudinal monofilament direction.

20. The sealing material as claimed in claim 4, wherein the PTFE monofilament has at least one groove running in longitudinal monofilament direction.
